(19) United States
(12) Patent Application Publication
(10) Pub. No.: US 2021/0279574 A1
(43) Pub. Date: Sep. 9, 2021

(54) METHOD, APPARATUS, SYSTEM, STORAGE MEDIUM AND APPLICATION FOR GENERATING QUANTIZED NEURAL NETWORK

(71) Applicant: CANON KABUSHIKI KAISHA, Tokyo (JP)

(72) Inventors: Junjie Liu, Beijing (CN); Tsewei Chen, Tokyo (JP); Dongchao Wen, Beijing (CN); Wei Tao, Beijing (CN); Deyu Wang, Beijing (CN)

(21) Appl. No.: 17/189,014

(22) Filed: Mar. 1, 2021

(30) Foreign Application Priority Data
Mar. 4, 2020 (CN) 202010142443.X

(51) Int. Cl. G06N 3/08; G06N 3/04

(52) U.S. Cl. CPC G06N 3/08; G06N 3/04

(57) ABSTRACT

A method of generating a quantized neural network comprises: determining, based on a floating-point weight in a neural network to be quantized, networks which correspond to the floating-point weights and are used for directly outputting quantized weights, respectively; quantizing, using the determined network, the floating-point weight corresponding to the network to obtain a quantized neural network; updating, based on a loss function value obtained via the quantized neural network, the determined network, the floating-point weight and the quantized weight in the quantized neural network.

### BACKGROUND

### Field of the Disclosure

The present disclosure relates to image processing, and in particularly to a method, an apparatus, a system, a storage medium and an application for generating a quantized neural network, for example.

### Description of the Related Art

At present, deep neural networks (DNNs) are widely used in various tasks. With an increase of various parameters in the networks, the resource load has become an issue of applying the DNNS to the practical industrial application. In order to reduce storage and computing resources needed in the practical application, quantizing neural networks has become conventional means.

In the process of quantizing neural networks (i.e., in the process of generating quantized neural networks), an issue that gradients do not match (i.e., loss of gradient information) will be caused since a large number of non-differentiable functions (e.g., an operation of taking a sign (sign function)) are usually used, thereby affecting performance of the generated quantized neural networks. For the problem that the gradients do not match, the non-patent literature, Mixed Precision DNNs: All you need is a good parameterization (Stefan Uhlich, Lukas Mauch, Kazuki Yoshiyama, Fabien Cardinaux, Javier Alonso Garcia, Stephen Tiedemann, Thomas Kemp, Akira Nakamura; ICLR 2020), proposes an exemplary method. The non-patent literature discloses an approximate differentiable neural network quantizing method. This exemplary method introduces, in the process of quantizing floating-point weights of the neural networks to be quantized using the sign function and a straight-through estimator (STE), auxiliary parameters obtained based on precision of the neural networks to be quantized, thereby performing smoothing processing for a variance of the reverse gradient corresponding to the quantized weight obtained by estimation by the STE using the auxiliary parameters, and achieving the purpose of correcting the gradient.

As can be known from the above, it still needs to use the non-differentiable function in the above-mentioned exemplary method, which only alleviates the issue that the gradients do not match in the neural network quantizing process by introducing the auxiliary parameters. Since in the neural network quantizing process, the issue that the gradients do not match still exists, that is, the issue of loss of gradient information still exists, thus the performance of the generated quantized neural network will still be affected.

### SUMMARY

In view of the recordation in the above Related Art, the present disclosure is directed to solve at least one of the above issues.

According to an aspect of the present disclosure, there is provided a method of generating a quantized neural network, the method comprising: determining, based on floating-point weights in a neural network to be quantized, networks which correspond to the floating-point weights and are used for directly outputting quantized weights, respectively; quantizing, using the determined network, the floating-point weight corresponding to the network to obtain the quantized neural network; and updating, based on a loss function value obtained via the quantized neural network, the determined network, the floating-point weight and the quantized weight in the quantized neural network.

According to a further aspect of the present disclosure, there is provided a system for generating a quantized neural network, the system comprising: a first embedded device that determines, based on floating-point weights in a neural network to be quantized, networks which correspond to the floating-point weights and are used for directly outputting quantized weights, respectively; a second embedded device that quantizes, using the network determined by the first embedded device, the floating-point weight corresponding to the network to obtain the quantized neural network; and a server that calculates a loss function value via the quantized neural network obtained by the second embedded device, and updates the determined network, the floating-point weight and the quantized weight in the quantized neural network based on the loss function value obtained by calculation, wherein the first embedded device, the second embedded device and the server are connected to each other via a network.

Wherein, in the present disclosure, one floating-point weight in the neural network to be quantized corresponds to one network for directly outputting the quantized weight. In the present disclosure, the network for directly outputting the quantized weight can be for example referred to as a meta-network. Wherein, in the present disclosure, one meta-network includes: a module for convolving floating-point weights; and a first objective function for constraining an output of the module for convolving the floating-point weights. Wherein, for one floating-point weight in the neural network to be quantized and the meta-network corresponding to the floating-point weight, the first objective function in the network preferentially tends elements that can reduce loss of an objective task in the output of the module for convolving floating-point weights to the quantized weight based on a priority of the elements in the floating-point weight.

According to another further aspect of the present disclosure, there is provided a method of applying a quantized neural network, the method comprising: loading a quantized neural network; inputting, to the quantized neural network, a data set which is required to correspond to a task which can be executed by the quantized neural network; performing operation on the data set in each layer in the quantized neural network from top to bottom; and outputting a result. Wherein, the loaded quantized neural network is a quantized neural network obtained according to the method of generating the quantized neural network.

As can be known from the above, in the process of quantizing the neural network, the present disclosure uses a meta-network capable of directly outputting the quantized weight to replace the sign function and the STE needed in the conventional method, and generates the quantized neural network in a manner of training the meta-network and the neural network to be quantized cooperatively, thereby achieving the purpose of not losing information. Therefore, according to the present disclosure, the issue that the gradients do not match in the neural network quantizing process can be solved, thereby improving the performance of the generated quantized neural network.

Further features and advantages of the present disclosure will become apparent from the following description of typical embodiments with reference to the attached drawings.

### BRIEF DESCRIPTION OF THE DRAWINGS

The accompanying drawings, which are incorporated in and constitute a part of the specification, illustrate embodiments of the present disclosure and, together with the description of the embodiments, serve to explain the principles of the present disclosure.

FIG. 1 is a block diagram schematically illustrating a hardware configuration which is capable of implementing a technique according to an embodiment of the present disclosure.

FIG. 2 is an example schematically illustrating a meta-network for directly outputting a quantized weight according to an embodiment of the present disclosure.

FIG. 3 is a structure schematically illustrating a module 210 for convolving floating-point weights as shown in FIG. 2 according to an embodiment of the present disclosure.

FIG. 4A is an example schematically illustrating that each module in a meta-network consists of one neural network layer respectively according to an embodiment of the present disclosure.

FIG. 4B is an example schematically illustrating that each module in a meta-network consists of different number of neural network layers respectively according to an embodiment of the present disclosure.

FIG. 5 is a configuration block diagram schematically illustrating an apparatus for generating a quantized neural network according to an embodiment of the present disclosure.

FIG. 6 is a flow chart schematically illustrating a method of generating a quantized neural network according to an embodiment of the present disclosure.

FIG. 7 is a flow chart schematically illustrating an update step S630 as shown in FIG. 6 according to an embodiment of the present disclosure.

FIG. 8 is an example schematically illustrating a structure diagram of generating a quantized neural network by quantizing a neural network to be quantized, consisting of three network layers, according to an embodiment of the present disclosure.

FIG. 9 is an example schematically illustrating a structure of a meta-network for generating the quantized weight on the last floating-point weight as shown in FIG. 8 according to an embodiment of the present disclosure.

FIG. 10 is a configuration block diagram schematically illustrating a system for generating a quantized neural network according to an embodiment of the present disclosure.

### DESCRIPTION OF THE EMBODIMENTS

Exemplary embodiments of the present disclosure will be described in detail below with reference to the drawings. It should be noted that the following description is illustrative and exemplary in nature and is in no way intended to limit the disclosure, its application or uses. The relative arrangement of the components and steps, the numerical expressions, and numerical values set forth in these embodiments do not limit the scope of the present disclosure unless it is specifically stated otherwise. In addition, the techniques, methods and devices known by persons skilled in the art may not be discussed in detail, however, they shall be a part of the present specification under a suitable circumstance.

It is noted that, similar reference numbers and letters refer to similar items in the drawings, and thus once an item is defined in one figure, it may not be discussed in the following figures. The present disclosure will be described in detail below with reference to the drawings.

(Hardware Configuration)

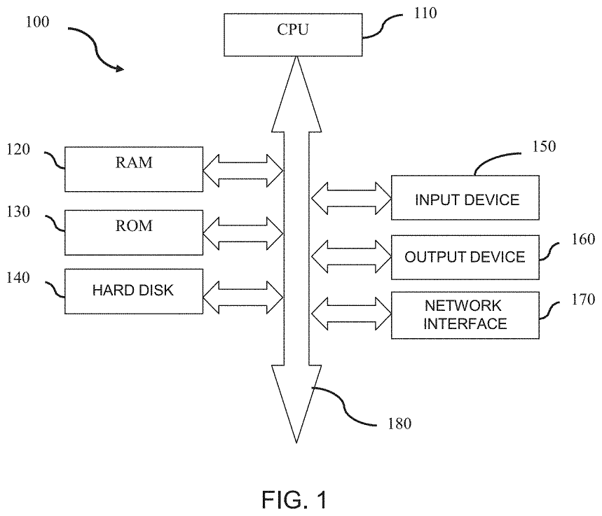

At first, the hardware configuration capable of implementing the technique described below will be described with reference to FIG. 1.

The hardware configuration 100 includes for example a central processing unit (CPU) 110, a random access memory (RAM) 120, a read only memory (ROM) 130, a hard disk 140, an input device 150, an output device 160, a network interface 170 and a system bus 180. In one implementation, the hardware configuration 100 can be implemented by a computer such as a tablet computer, a laptop, a desktop or other suitable electronic devices.

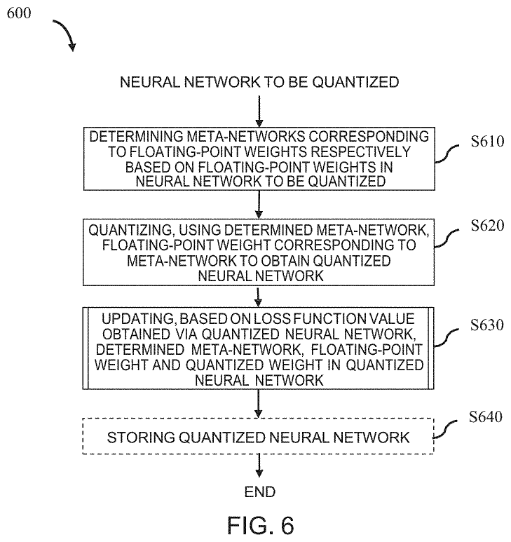

In one implementation, an apparatus for generating a quantized neural network according to the present disclosure is configured by hardware or firmware, and serves as a module or a component of the hardware configuration 100. For example, an apparatus 500 for generating a quantized neural network that will be described in detail below with reference to FIG. 5 serves as a module or a component of the hardware configuration 100. In another implementation, the method of generating a quantized neural network according to the present disclosure is configured by software which is stored in the ROM 130 or the hard disk 140 and is executed by the CPU 110. For example, the procedure 600 that will be described in detail below with reference to FIG. 6 serves as a program stored in the ROM 130 or the hard disk 140.

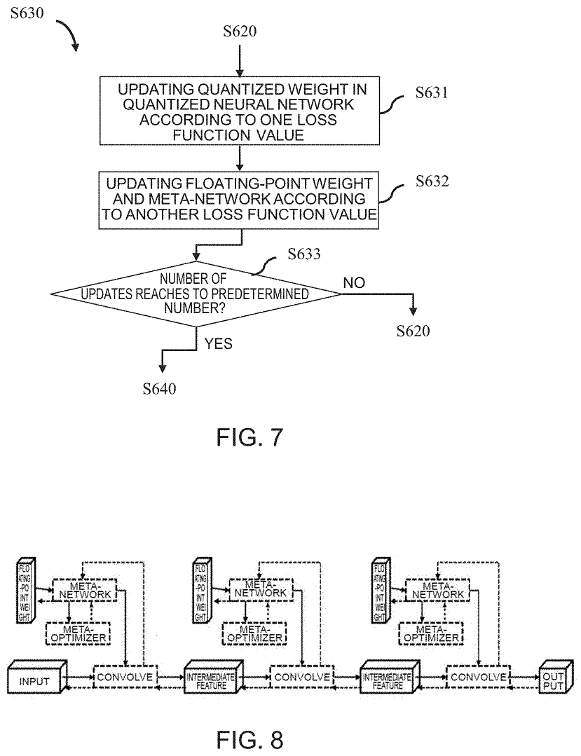

The CPU 110 is any suitable programmable control device (e.g. a processor) and can execute various functions to be described below by executing various application programs stored in the ROM 130 or the hard disk 140 (e.g. a memory). The RAM 120 is used for temporarily storing programs or data loaded from the ROM 130 or the hard disk 140, and is also used as a space in which the CPU 110 executes various procedures (e.g. implementing the technique to be described in detail below with reference to FIGS. 6 to 7) and other available functions. The hard disk 140 stores many kinds of information such as operating systems (OS), various applications, control programs, neural networks to be quantized, generation of obtained quantized neural networks, predefined data (e.g. threshold values (THs)) or the like.

In one implementation, the input device 150 is used for allowing a user to interact with the hardware configuration 100. In one example, the user can input for example neural networks to be quantized, specific task processing information (e.g. object detection task), etc., via the input device 150, wherein the neural networks to be quantized include for example various weights (e.g. floating-point weights). In another example, the user can trigger the corresponding processing of the present disclosure via the input device 150. Further, the input device 150 can adopt a plurality of forms, such as a button, a keyboard or a touch screen.

In one implementation, the output device 160 is used for storing the finally generated and obtained quantized neural network in the hard disk 140 for example, or is used for outputting the finally generated quantized neural network to specific task processing such as object detection, object classification, image segmentation, etc.

The network interface 170 provides an interface for connecting the hardware configuration 100 to a network. For example, the hardware configuration 100 can perform data communication with other electronic devices that are connected by a network via the network interface 170. Alternatively, the hardware configuration 100 may be provided with a wireless interface to perform wireless data communication. The system bus 180 can provide a data transmission path for mutually transmitting data among the CPU 110, the RAM 120, the ROM 130, the hard disk 140, the input device 150, the output device 160, the network interface 170, etc. Although being referred to as a bus, the system bus 180 is not limited to any specific data transmission technique.

The above hardware configuration 100 is only illustrative and is in no way intended to limit the present disclosure, its application or uses. Moreover, for the sake of simplification, only one hardware configuration is illustrated in FIG. 1. However, a plurality of hardware configurations may also be used as required. For example, a meta-network capable of directly outputting the quantized weight that will be described below can be obtained in one hardware structure, the quantized neural network can be obtained in another hardware structure, and the operation such as calculation involved herein can be executed by a further hardware structure, wherein these hardware structures can be connected by a network. In such a case, the hardware structure for obtaining the meta-network and the quantized neural network can be implemented by for example an embedded device, such as a camera, a video camera, a personal digital assistant (PDA) or other suitable electronic devices, and the hardware structure for executing the operation such as calculation can be implemented by for example a computer (such as a server).

(Meta-Network)

In order to avoid using the sign function and the STE which will cause loss of information (i.e., gradient mismatch) in the process of quantizing floating-point weights in the neural network to be quantized, the inventors consider that the sign function and the STE can be replaced by correspondingly designing one meta-network capable of directly outputting the quantized weight for each floating-point weight, thereby achieving the purpose of losing no information. In addition, in the process of quantizing floating-point weights in the neural network to be quantized, not all floating-point weights are important in fact. For example, since the performance of the generated quantized neural network will also be affected greatly even if information is lost slightly in the process of quantizing the floating-point weight with a high importance degree, it is necessary to ensure that their quantized weights more tend to “+1” or “−1” when the floating-point weight with a high importance degree is quantized. In the process of quantizing the floating-point weight with a low importance degree, the performance of the generated quantized neural network will not be affected even if information is lost slightly; moreover, the purpose of quantizing the floating-point weight is to obtain a quantized neural network with the best performance, instead of tending the quantized weights of all floating-point weights to “+1” or “4”, such that it is unnecessary to tend their quantized weights to “+1” or “−1” accurately when the floating-point weight with a low importance degree is quantized.

Wherein, in the present disclosure, the floating-point weight with a high importance degree can be further defined by the following mathematical assumption. It is assumed that all vectors v belong to a n-dimensional real-number set Rⁿ and each have one k sparse representation, and meanwhile, there is a minimal ε (which belongs to (0, 1)) and an optimal quantized weight w*_{q}. Wherein, accompanied by applying the task objective function [symbol] to the specific task in the process of updating and optimizing the quantized neural network, the updating and optimizing process can have attributes expressed by the following formulas (1) and (2):

$${lim}_{{w}_{q} \to {w}_{q}^{*}} {‖ ℓ ( {w}_{q} ) - ℓ ( sign ( {w}_{q} ) ) ‖}_{2}^{2} = 0 \\ s . t ( 1 - ∈ ) \leq \frac{ℓ ( {w}_{q}^{*} v )}{ℓ ( {w}_{q}^{*} )} \leq ( 1 + ∈ ) \qquad ( 1 )$$

(2)
   In the above formula (1), [symbol] (w_{q}) indicates a loss function value obtained on the quantized weight based on the task objective function, sign (w_{q}) indicates an operation of taking a sign, and w_{q} indicates the quantized weight. In the above formula (2), “s.t” indicates that the formula (1) is constrained by the formula (2).

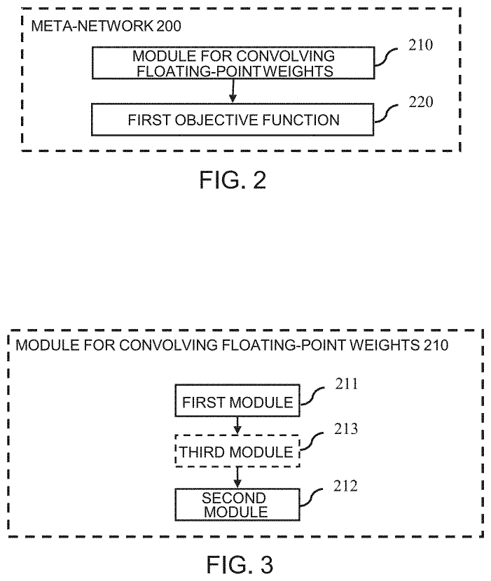

Therefore, the inventors deem that, in order to be helpful for generating the quantized weight with a higher accuracy, corresponding to one floating-point weight in the neural network to be quantized, the meta-network capable of directly outputting the quantized weight thereof can be designed to have the structure as shown in FIG. 2. As shown in FIG. 2, the meta-network 200 capable of directly outputting the quantized weight includes: a module 210 for convolving floating-point weights; and a first objective function 220 for constraining an output of the module 210 for convolving the floating-point weights. Wherein, in order to be helpful for preserving a geometric manifold structure of the floating-point weight, the module 210 for convolving the floating-point weights can be designed to have the structure as shown in FIG. 3. As shown in FIG. 3, the module 210 for convolving the floating-point weights includes: a first module 211 for converting a dimension of the floating-point weight; and a second module 212 for converting the dimension of the output of the first module 211 into a dimension of the floating-point weight. Wherein, in order to save computing resources when the neural network is quantized, the module 210 for convolving the floating-point weights can further include: a third module 213 for extracting principal components from the output of the first module 211; at this time, the second module 212 is used for converting the dimension of the output of the third module 213 into a dimension of the floating-point weight. Wherein, input shape sizes and output channel numbers of the first module 211, the second module 212 and the third module 213 are determined based on a shape size of the floating-point weight. Wherein, the constrain of the first objective function 220 for the output of the module 210 for convolving the floating-point weights is: preferentially tend the elements in the output of the module 210 for convoluting the floating-point weights that are helpful for reducing loss of the objective task (i.e., helpful for improving performance of the task) to the quantized weight based on a priority of the elements in the floating-point weight.

Hereinafter, explanation is performed by taking a floating-point weight w in the neural network to be quantized as an example, wherein a matrix shape of the floating-point weight is for example [a width of a convolution kernel, a height of the convolution kernel, a number of input channels and a number of output channels]. In one implementation, the first module 211 can be used as a coding function module for converting the floating-point weight w into a high dimension. Specifically, in order to convert the floating-point weight w into a high-dimension structure so as to generate features with more distinctiveness for the objective task, the input shape size of the coding function module can be set to be the same as the matrix shape size of the floating-point weight w, and the number of output channels of the coding function module can be set to be at least four times greater than or equal to the square of a size of the convolution kernel of the floating-point weight w, wherein the square of a size of convolution kernel of the floating-point weight w is also a product of the “width of the convolution kernel” and the “height of the convolution kernel”.

The third module 213 can be used as a compressing function module for analyzing principal components of the output result of the encoding function module, compressing and extracting the principal components. Specifically, in order to extract the principal components of the converted high-dimension structure to filter out the priority of each element, the input shape size of the compressing function module can be set to be the same as the output shape size of the encoding function module, and the number of output channels of the compressing function module can be set to be at least twice greater than or equal to a size of the convolution kernel of the floating-point weight, but meanwhile less than or equal to a half of the number of output channels of the coding function module.

The second module 212 can be used as a decoding function module for activating and decoding an output result of the coding function module or the compressing function module. Specifically, in order to restore the dimension of the floating-point weight w to generate the quantized weight, the input shape size of the decoding function module can be set to be the same as the output shape size of the coding function module or the compressing function module, and the number of output channels of the decoding function module can be set to be the same as the matrix shape size of the floating-point weight.

The first objective function 220 can be used as a quantized objective function for constraining an output result of the decoding function module to obtain a quantized weight w_{q} of the floating-point weight w. Wherein, in order to derive the quantized objective function, the following assumption can be defined in the present disclosure:

Assuming that there is a functional F(w), and meanwhile, a function tan h(F(w)) is formed, such that the gradient in the hyperbolic tangent function tan h(F(w)) for w can be expressed as the following formulas (3) and (4):

$$\begin{matrix}{lim}_{w \to ∞} \frac{\partial tanh ( F ( w ) )}{\partial w} \neq 0 & ( 3 ) \\ w . r . t ∇ tanh ( F ( w ) ) = \frac{\partial F ( w )}{\partial w} ( 1 - {tanh}^{2} ( F ( w ) ) ) & ( 4 )\end{matrix}$$

In the above formula (4), “w.r.t” indicates that the formula (4) belongs to extension of the formula (3), and V indicates to take a gradient for the function tan h(F(w)).

Specifically, in the present disclosure, the quantized objective function can be for example defined as the following formula (5):

$${w}_{q}^{*} = {arg min}_{{w}_{q}} {‖ b - \sqrt{{w}_{q}^{2}} ‖}_{2} + ‖ {w}_{q} ‖ , s . t . b ∈ {\{ 1 \}}^{m n} \qquad ( 5 )$$

In the above formula (5), b indicates a quantized reference vector, which functions to constrain the output result of the decoding function module to tend to the quantized weight w_{q}; w*_{q} indicates to an optimal quantized weight obtained after optimizing and constraining, wherein w_{q} and w*_{q} are vectors, which belong to a mn-dimentional real-number set; m and n indicate a number of input channels and a number of output channels of the quantized weight; ∥w_{q}∥ indicates a L1 normal operator, which functions to identify a priority of each element in the floating-point weight w by the sparsity rule, wherein the operator having a priority of identifying each element in the floating-point weight w can be used.

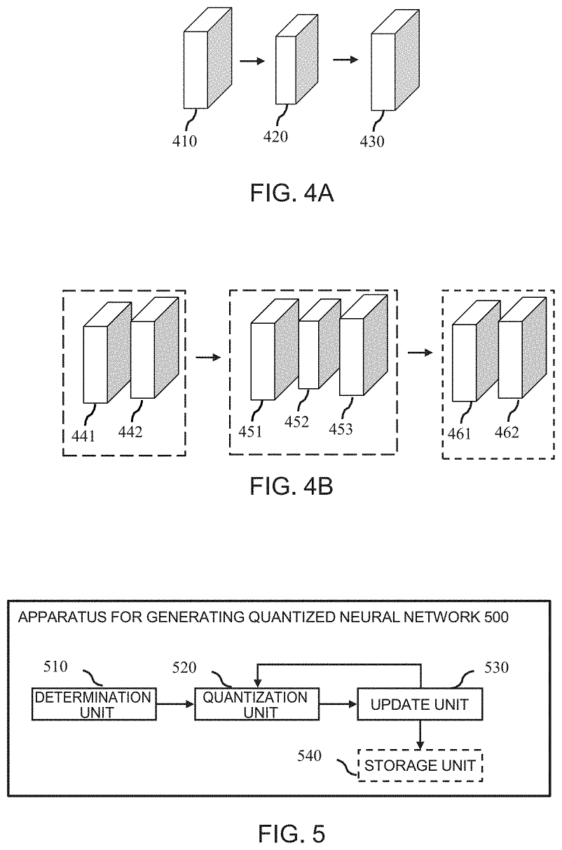

Further, in the present disclosure, the coding function module (i.e., the first module 211), the compressing function module (i.e., the third module 213) and the decoding function module (i.e., the second module 212) can consist of at least one neural network layer (e.g. full-connection layer), respectively. Wherein, the number of neural network layers constituting each function module can be decided by the accuracy of the quantized neural network that needs to be generated. Taking that the module 210 for convolving the floating-point weights simultaneously includes the coding function module, the compressing function module and the decoding function module as an example, in one implementation, the coding function module consists of a full-connection layer 410, the compressing function module consists of a full-connection layer 420, and the decoding function module consists of a full-connection layer 430 for example as shown in FIG. 4A. In another implementation, the coding function module consists of full-connection layers 441-442, the compressing function module consists of full-connection layers 451-453, and the decoding function module consists of full-connection layers 461-462 for example as shown in FIG. 4B. However, apparently, the present disclosure is not limited to this. The number of neural network layers constituting each function module can be set according to the accuracy of the quantized neural network that actually needs to be generated. In addition, the input and output shape sizes of the neural network layers constituting each function module are not particularly defined in the present disclosure.

(Apparatus and Method for Generating a Quantized Neural Network)

Next, by taking an example of implementing by one hardware configuration, generation of the quantized neural network according to the present disclosure will be described with reference to FIGS. 5 to 9.

FIG. 5 is a configuration block diagram schematically illustrating an apparatus 500 for generating a quantized neural network according to an embodiment of the present disclosure. Wherein, a part of or all of modules shown in FIG. 5 can be implemented by specialized hardware. As shown in FIG. 5, the apparatus 500 includes a determination unit 510, a quantization unit 520 and an update unit 530. Further, the apparatus 500 can also include a storage unit 540.

First, for example, the input device 150 shown in FIG. 1 receives the neural network to be quantized, definition to the floating-point weight in each network layer, etc., which are input by a user. Next, the input device 150 transmits the received data to the apparatus 500 via the system bus 180.

Then, as shown in FIG. 5, the determination unit 510 determines, based on a floating-point weight in the neural network to be quantized, networks (i.e., the above “meta-network”) which correspond to the floating-point weight and are used for directly outputting the quantized weight, respectively. Normally, how many floating-point weights need to be quantized correspondingly depending on how many network layers constitute one neural network to be quantized. Thus, in a case where the number of floating-point weights needing to be quantized is N, the determination unit 510 determines one corresponding meta-network for each floating-point weight. Wherein, the determined meta-network can be initialized in a traditional manner of initializing the neural network (e.g. Gaussian distribution in which the mean value is 0 and the variance is 1).

The quantization unit 520, using the meta-network determined by the determination unit 510, quantizes the floating-point weight corresponding to the meta-network, so as to obtain the quantized neural network. That is to say, the quantization unit 520 quantizes each floating-point weight using the meta-network corresponding to the floating-point weight, so as to obtain the corresponding quantized weight. After all floating-point weights are quantized, the corresponding quantized neural network can be obtained.

The update unit 530 updates the meta-network determined by the determination unit 510, the floating-point weight in the neural network to be quantized and the quantized weight in the quantized neural network based on the loss function value obtained via the quantized neural network.

In addition, the update unit 530 further judges whether the quantized neural network after being updated satisfies a predetermined condition, e.g. the total number of updates (for example, T times) has already been completed or the predetermined performance has already been achieved (e.g. the loss function value tends to a constant value). If the quantized neural network does not satisfy the predetermined condition yet, the quantization unit 520 and the update unit 530 will execute the corresponding operation again.

If the quantized neural network has already satisfied the predetermined condition, the storage unit 540 stores the quantized neural network obtained by the quantization unit 520, thereby applying the quantized neural network to the subsequent specific task processing such as object detection, object classification, image segmentation, etc.

The method flow chart 600 shown in FIG. 6 is a corresponding procedure of the apparatus 500 shown in FIG. 5. As shown in FIG. 6, for the neural network to be quantized, the determination unit 510 determines in the determination step S610, based on a floating-point weight in the neural network to be quantized, networks (i.e., the above “meta-network”) which correspond to the floating-point weight and are used for directly outputting the quantized weight, respectively. As stated above, the determination unit 510 determines one corresponding meta-network for each floating-point weight.

In the quantization step S620, the quantization unit 520 quantizes, using the meta-network determined in the determination step S610, the floating-point weight corresponding to the meta-network, so as to obtain the quantized neural network. That is to say, in the quantization step S620, the quantization unit 520 quantizes each floating-point weight using the meta-network corresponding to the floating-point weight, so as to obtain the corresponding quantized weight. After all floating-point weights are quantized, the corresponding quantized neural network can be obtained. For an arbitrary floating-point weight (e.g. floating-point weight w), in one implementation, the floating-point weight w can be quantized for example by the following operation:

First, the quantization unit 520 transforms the floating-point weight w and inputs the transformation result as a meta-network corresponding to the floating-point weight w. As can be seen from the above, the matrix shape of the floating-point weight w is [a width of a convolution kernel, a height of the convolution kernel, a number of input channels and a number of output channels]. That is to say, the matrix shape of the floating-point weight w is a four-dimensional matrix. After the transformation operation, the matrix shape of the floating-point weight w is transformed into a two-dimensional matrix, whose matrix shape is [a width of the convolution kernel×a height of the convolution kernel, and a number of input channels×a number of output channels].

Then, the quantization unit 520 quantizes the transformed floating-point weight w using the meta-network corresponding to the floating-point weight w, so as to obtain the corresponding quantized weight. Since the input of the meta-network is a two-dimensional matrix, the matrix shape of the obtained quantized weight is also a two-dimensional matrix. Thus, the quantization unit 520 also needs to transform the obtained quantized weight to have a matrix shape that is the same as the matrix shape of the floating-point weight w, that is, needs to transform the matrix shape of the quantized weight to be a four-dimensional matrix.

Returning to FIG. 6, after all floating-point weights are quantized, in the update step S630, the update unit 530 updates the meta-network determined by the determination unit 510, the floating-point weight in the neural network to be quantized and the quantized weight in the quantized neural network based on the loss function value obtained via the quantized neural network.

Further, after the operation of the update step S630 ends, in the storage step S640, the storage unit 540 stores the quantized neural network obtained in the quantization step S620, thereby applying the quantized neural network to the subsequent specific task processing such as object detection, object classification, image segmentation, etc. Wherein, for example, the quantized weight in the quantized neural network or the fixed-point weight after the quantized weight is enabled fixed-point is stored in the storage unit 540. Wherein, the operation for fixed-point the quantized weight is for example the rounding operation of the quantized weight.

In one implementation, in order to improve accuracy of the generated quantized neural network, the update unit 530 executes the corresponding update operation referring to FIG. 7 in the update step S630 shown in FIG. 6.

As shown in FIG. 7, in step S631, the update unit 530 updates the quantized weight in the quantized neural network obtained in the quantization step S620 based on the loss function value. Wherein, in the present disclosure, the loss function value can be for example referred to as a task loss function value. Wherein, the task loss function value is obtained based on the second objective function for updating the quantized neural network. Wherein, in the present disclosure, the second objective function can be for example referred to as a task objective function. Wherein, the task objective function can be set as different functions according to different tasks. For example, in a case where a corresponding quantized neural network is generated for the face detection task with the present disclosure, the task objective function can be set as an actual detection function for the face detection, for example, the objective detection function used in YOLO. In one implementation, the update unit 530 updates the quantized weight in the quantized neural network in the following manner for example:

First, the update unit 530 performs the forward propagation operation using the quantized neural network obtained in the quantization step S620, and calculates the task loss function value according to the task objective function.

Then, the update unit 530 updates the quantized weight using the function for updating the quantized weight, based on the task loss function value obtained by calculation. Wherein, the function for updating the quantized weight can be defined as the following formula (6) for example:

$${g}_{Θ} = \frac{\partial ℓ}{\partial {W}_{q}} \frac{\partial {W}_{q}}{\partial Θ} = {g}_{{W}_{q}} \frac{\partial {W}_{q}}{\partial Θ} \qquad ( 6 )$$

In the above formula (6), [symbol] indicates a task objective loss function value; g_{w}_{_{q}} indicates a gradient of the quantized weight, which is used for updating the quantized weight; Θ indicates parameters in the meta-network; and g_{Θ} indicates a gradient of the weight in the meta-network itself, which is used for updating the meta-network.

Returning to FIG. 7, in step S632, the update unit 530 updates the floating-point weight and the determined meta-network based on another loss function value. Wherein, in the present disclosure, the loss function value can be for example referred to as a quantized loss function value. Wherein, the quantized loss function value is obtained based on the updated quantized weight and the first objective function (i.e., quantized objective function) in the meta-network. Corresponding to one of the updated quantized weights, in one implementation, the update unit 530 updates the floating-point weight for obtaining the quantized weight and the corresponding meta-network in the following manner:

On one hand, the update unit 530 updates the floating-point weight using the function for updating the floating-point weight, based on the gradient value obtained by calculation through the above formula (6). Wherein, the function for updating the floating-point weight for example can be defined as the following formula (7):

w^{t+1}=w^{t}−ηg_{Θ} (7)

In the above formula (7), η indicates a training learning rate of the meta-network, t indicates a number of times of updating the current quantized neural network (i.e., a number of training iterations), and wₜ indicates a floating-point weight for the t^{th} update.

On one hand, the update unit 530 updates the weight in the meta-network itself using the general backward propagation operation, based on the quantized loss function value obtained by calculation.

Further, in the present disclosure, two update operations executed by the update unit 530 can be jointly trained using two independent neural network optimizers, respectively.

Returning to FIG. 7, in step S633, the update unit 530 judges whether the number of times of executing the update operation reaches to a predetermined total number of updates (for example, T times). In a case where the number of times of executing the update is smaller than T, the procedure will proceed to the quantization step S620 again. Otherwise, the procedure will proceed to the storage step S640. That is, the quantized neural network updated for the last time will be stored in the storage unit 540, thereby applying the quantized neural network to the subsequent specific task processing such as object detection, object classification, image segmentation, etc.

In the flow S630 shown in FIG. 7, whether the number of updates reaches to a predetermined total number of updates is used as a condition of stopping the update operation. However, apparently, the present disclosure is not limited to this. Alternatively, whether the loss function value (e.g. the above task loss function value) tends to the constant value is used as a condition of stopping the update operation.

As an example, the operation flow of generating the quantized neural network according to an embodiment of the present disclosure will be described below:

```
inputting: a floating-point weight w, a meta-network Q and its parameter
Θ,
        a training set {X,Y}, a number t of training iterations and
        ϵ=1e−5;
outputting: an optimal quantized weight W_{q}^{*};
training phase: for each layer
circulating t=0; executing in the case where t ≤T
    forward propagation
      calculating W_{q}^{t} by tanh(Q_{_{Θ}}ₜ (W^{t}));
      calculating [symbol]   (W_{q}^{t}, {x^{t}, y^{t}}), and by W_{q}^{t} and {x^{t}, y^{t}};
    backward propagation
      calculating ∇W_{q}^{t} by [symbol]   (W_{q}^{t}, {x^{t}, y^{t}});
      calculating ∇Θ^{t} by the above formulas (6) and (5);
      updating W^{t} by the above formula (7);
ending circulation
predicting phase: for each layer
  W_{q}^{*} = rounding (W_{q}^{T})
```

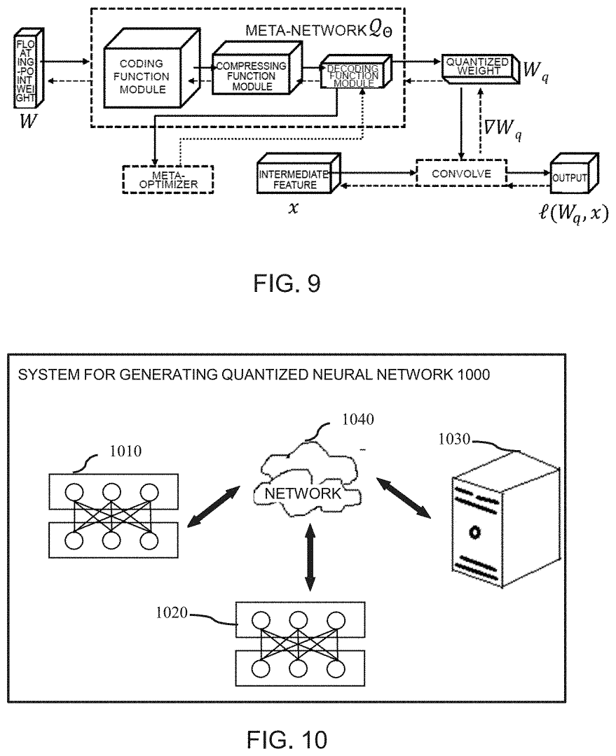

In addition, as stated above, how many floating-point weights need to be quantized correspondingly depending on how many network layers constitute one neural network to be quantized. Therefore, as an example, taking that the neural network to be quantized consists of three network layers as an example, this neural network to be quantized according to an embodiment of the present disclosure is quantized to obtain a structure diagram of the corresponding quantized neural network for example shown in FIG. 8. As shown in FIG. 8, the output of each shown meta-network is a quantized weight corresponding to the floating-point weight for inputting the meta-network, and the shown meta-optimizer is the neural network optimizer for updating the meta-network. Wherein, in FIG. 8, dot dashed lines between the meta-network and the meta-optimizer indicate the backward propagation gradient constrained by the meta-network, and the remaining dashed lines indicate the backward propagation gradient of the quantized neural network. Further, as stated above, in the present disclosure, the module for convolving the float-point weights in the meta-network can consist of the coding function module, the compressing function module and the decoding function module for example. Therefore, as an example, the structure of the meta-network for generating the quantized weight on the last floating-point weight as shown in FIG. 8 is for example as shown in FIG. 9. Wherein, in FIG. 9, dot dashed lines between the decoding function module and the meta-optimizer indicate the backward propagation gradient constrained by the meta-network, and the remaining dashed lines indicate the backward propagation gradient of the quantized neural network.

As stated above, in the process of quantizing the neural network, the present disclosure uses a meta-network capable of directly outputting the quantized weight to replace the sign function and the STE needed in the conventional method, and generates the quantized neural network in a manner of training the meta-network and the neural network to be quantized cooperatively, thereby achieving the purpose of losing no information. Therefore, according to the present disclosure, the problem that the gradients do not match in the neural network quantizing process can be solved, thereby improving the performance of the generated quantized neural network.

(System for Generating the Quantized Neural Network)

As illustrated in FIG. 1, as one application of the present disclosure, generation of the quantized neural network according to the present disclosure will be described below with reference to FIG. 10 by taking an example of implementing by three hardware configuration.

FIG. 10 is a configuration block diagram schematically illustrating a system 1000 for generating a quantized neural network according to an embodiment of the present disclosure. As shown in FIG. 10, the system 1000 includes a first embedded device 1010, a second embedded device 1020 and a server 1030, wherein the first embedded device 1010, the second embedded device 1020 and the server 1030 are connected to each other via a network 1040. Wherein, the first embedded device 1010 and the second embedded device 1020 for example can be an electronic device such as a video camera or the like, and the server for example can be an electronic device such as a computer or the like.

As shown in FIG. 10, the first embedded device 1010 determines, based on a floating-point weight in the neural network to be quantized, networks (i.e., meta-networks) which correspond to the floating-point weight and are used for directly outputting the quantized weight, respectively.

The second embedded device 1020 quantizes, using the meta-network determined by the first embedded device 1010, the floating-point weight corresponding to the meta-network to obtain the quantized neural network.

The server 1030 calculates the loss function value via the quantized neural network obtained by the second embedded device 1020, and updates the determined meta-network, the floating-point weight and the quantized weight in the quantized neural network based on the loss function value obtained by calculation. Wherein, the server 1030, after updating the meta-network, the floating-point weight and the quantized weight in the quantized neural network, transmits the updated meta-network to the first embedded device 1010, and transmits the updated floating-point weight and quantized weight to the second embedded device 1020.

All the above units are illustrative and/or preferable modules for implementing the processing in the present disclosure. These units may be hardware units (such as Field Programmable Gate Array (FPGA), Digital Signal Processor, Application Specific Integrated Circuit and so on) and/or software modules (such as computer readable program). Units for implementing each step are not described exhaustively above. However, in a case where a step for executing a specific procedure exists, a corresponding functional module or unit for implementing the same procedure may exist (implemented by hardware and/or software). The technical solutions of all combinations by the described steps and the units corresponding to these steps are included in the contents disclosed by the present application, as long as the technical solutions constituted by them are complete and applicable.

The methods and apparatuses of the present disclosure can be implemented in various forms. For example, the methods and apparatuses of the present disclosure may be implemented by software, hardware, firmware or any other combinations thereof. The above order of the steps of the present method is only illustrative, and the steps of the method of the present disclosure are not limited to such order described above, unless it is stated otherwise. In addition, in some embodiments, the present disclosure may also be implemented as programs recorded in recording medium, which include a machine readable instruction for implementing the method according to the present disclosure. Therefore, the present disclosure also covers the recording medium storing programs for implementing the method according to the present disclosure.

While some specific embodiments of the present disclosure have been demonstrated in detail by examples, it is to be understood for persons skilled in the art that the above examples are only illustrative and does not limit to the scope of the present disclosure. In addition, it is to be understood for persons skilled in the art that the above embodiments can be modified without departing from the scope and spirit of the present disclosure. The scope of the present disclosure is restricted by the attached Claims.

This application claims the benefit of Chinese Patent Application No. 202010142443.X, filed Mar. 4, 2020, which is hereby incorporated by reference herein in its entirety.

What is claimed is:

1. A method of generating a quantized neural network comprising:
determining, based on floating-point weights in a neural network to be quantized, networks which correspond to the floating-point weights and are used for directly outputting quantized weights, respectively;
quantizing, using the determined network, the floating-point weight corresponding to the network to obtain a quantized neural network; and
updating, based on a loss function value obtained via the quantized neural network, the determined network, the floating-point weight and the quantized weight in the quantized neural network.

2. The method according to claim 1, wherein, the determined network includes:
a module for convolving floating-point weights; and
a first objective function for constraining an output of the module for convolving the floating-point weights.

3. The method according to claim 2, wherein the module for convolving the floating-point weights includes:
a first module for converting a dimension of the floating-point weight; and
a second module for converting a dimension of an output of the first module into a dimension of the floating-point weight.

4. The method according to claim 3, wherein the module for convolving the floating-point weights further includes:
a third module for extracting principal components from the output of the first module,
wherein, the second module is used for converting a dimension of an output of the third module into a dimension of the floating-point weight.

5. The method according to claim 4, wherein, for one floating-point weight in the neural network to be quantized and the determined network corresponding to the floating-point weight, input shape sizes and numbers of output channels of the first module, the second module and the third module in the network are determined based on a shape size of the floating-point weight.

6. The method according to claim 4, wherein the first module, the second module and the third module comprise at least one neural network layer, respectively.

7. The method according to claim 2, wherein, for one floating-point weight in the neural network to be quantized and the determined network corresponding to the floating-point weight, the first objective function in the network preferentially tends elements that can reduce loss of an objective task in the output of the module for convolving the floating-point weights to a quantized weight based on a priority of the elements in the floating-point weight.

8. The method according to claim 1, wherein, the updating includes:
updating the quantized weight in the quantized neural network based on one loss function value, wherein the loss function value is obtained based on a second objective function for updating the quantized neural network; and
updating the floating-point weight and the determined network based on another loss function value, wherein the loss function value is obtained based on the updated quantized weight and the first objective function.

9. The method according to claim 1, further comprising:
storing the quantized neural network obtained in the quantization after the update is ended.

10. The method according to claim 9, wherein, in the storing, the quantized weight in the quantized neural network or the fixed-point weight after the quantized weight is enabled fixed-point are stored.

11. An apparatus for generating a quantized neural network, comprising:
a determination unit that determines, based on floating-point weights in a neural network to be quantized, networks which correspond to the floating-point weights and are used for directly outputting quantized weights, respectively;
a quantization unit that quantizes, using the determined network, the floating-point weight corresponding to the network to obtain a quantized neural network; and
an update unit that updates, based on a loss function value obtained via the quantized neural network, the determined network, the floating-point weight and the quantized weight in the quantized neural network.

12. The apparatus according to claim 11, wherein, the determined network includes:
a module for convolving floating-point weights; and
a first objective function for constraining an output of the module for convolving the floating-point weights.

13. The apparatus according to claim 12, wherein, for one floating-point weight in the neural network to be quantized and the determined network corresponding to the floating-point weight, the first objective function in the network preferentially tends elements that can reduce loss of an objective task in the output of the module for convolving the floating-point weights to a quantized weight based on a priority of the elements in the floating-point weight.

14. The apparatus according to claim 11, further comprising:
a storage unit configured to store the quantized neural network obtained by the quantization unit after the operation of the update unit is ended.

15. A system for generating a quantized neural network, characterized by comprising:
a first embedded device that determines, based on floating-point weights in a neural network to be quantized, networks which correspond to the floating-point weights and are used for directly outputting quantized weights, respectively;
a second embedded device that quantifies, using a network determined by the first embedded device, the floating-point weight corresponding to the network to obtain a quantized neural network; and
a server that calculates a loss function value via the quantized neural network obtained by the second embedded device, and updates, based on the calculated loss function value, the determined network, the floating-point weight and the quantized weight in the quantized neural network,
wherein the first embedded device, the second embedded device and the server are connected to each other via a network.

16. A non-transitory computer-readable storage medium storing instructions that, when executed by a processor, enable to execute generation of a quantized neural network, characterized in that the instructions comprise:
a determination step of determining, based on floating-point weights in a neural network to be quantized, networks which correspond to the floating-point weights and are used for directly outputting quantized weights, respectively;
a quantization step of quantizing, using the determined network, the floating-point weight corresponding to the network to obtain a quantized neural network; and
an update step of updating, based on a loss function value obtained via the quantized neural network, the determined network, the floating-point weight and the quantized weight in the quantized neural network.

17. A method of applying a quantized neural network, comprising:
loading a quantized neural network;
inputting, to the quantized neural network, a data set which is required to correspond to a task which can be executed by the quantized neural network;
performing operation on the data set in each layer in the quantized neural network from top to bottom; and
outputting a result.

18. The method according to claim 17, wherein the loaded quantized neural network is a quantized neural network obtained by a method comprising:
determining, based on floating-point weights in a neural network to be quantized, networks which correspond to the floating-point weights and are used for directly outputting quantized weights, respectively;
quantizing, using the determined network, the floating-point weight corresponding to the network to obtain a quantized neural network; and
updating, based on a loss function value obtained via the quantized neural network, the determined network, the floating-point weight and the quantized weight in the quantized neural network.
